(19) United States
(12) Patent Application Publication
(10) Pub. No.: US 2007/0172798 A1
(43) Pub. Date: Jul. 26, 2007

(54) Learning kits and method for tutoring and teaching learners

(76) Inventor: Catherine H. Thomas, South Euclid, OH (US)

Correspondence Address: PATRICK J. THOMAS, 20600 FAIRMOUNT BLVD # 3B, SHAKER HEIGHTS, OH, 44118, US

(21) Appl. No.: 11/656,114

(22) Filed: Jan. 22, 2007

Related U.S. Application Data
(60) Provisional application No. 60/761,236, filed on Jan. 23, 2006.

(51) Int. Cl. G09B 19/22

(52) U.S. Cl. 434/128

(57) ABSTRACT

The present invention is directed to a learning kit for tutoring learners comprising at least one copy of a book, at least one activity wherein the activity is in game format and is self-contained, a container for securing the contents of the learning kit, a learning kit instruction sheet; and a progress chart.

This application is filed within one year of and claims priority to Provisional Application Ser. No. 60/761,236 filed Jan. 23, 2006.

### FIELD OF THE INVENTION

The present invention is directed to a learning kit designed to be highly effective in tutoring subject matter such as reading comprehension, language development, vocabulary enrichment and phonics and phonemic awareness, as well as other academic subjects, for preschool to grade five level learners. The learning kit is designed to assist learners who are functioning below their academic peers and provides for a system that results in learners achieving success in relatively short periods of time. Moreover, the learning kit provides for a system that has a high rate of success over known methods in the educational arts. The invention is also directed to a method of tutoring by employing the learning kit and the kit's contents in a way that achieves success not previously attained by other methods known in the field.

### BACKGROUND OF THE INVENTION

It is known in the field of educational instruction that a substantial increase in personalized assistance, known as tutoring, is required for the academic progress of high-need, at-risk students in primary and secondary grade levels. A vast population of learners is entering school at the primary school grades with very limited reading ability, and consequently, an equally inadequate general academic potential. A variety of experimental and traditional tutoring programs and specialized techniques to deal with this problem have been employed but have yielded only partial successes at best and have failed to meet the challenge of this alarming educational problem.

One technique that has been found to be the most helpful in known tutoring systems is to employ the use of cognitive activities in conjunction with the reading of books. Although these practices sometimes work, there are severe limitations to them. First, there is very little relation, either of subject matter or otherwise, between the activities and the book itself. Second, the activities do little to reinforce any accomplishment made by the learner in reading the book. Third, the activities have required the attainment and procurement of numerous external sources required for their implementation, and often these sources are either simply unavailable or too time consuming to be a realistic approach. Fourth, the activities themselves are mundane and lack the stimulation necessary to make the process of engaging the activities effective. Finally, tutors themselves are similarly disengaged because their participation is at a minimum. All of these qualities act to quell progress that should and could be made during individual or small group tutoring processes.

There exists a need in the educational arts to develop a tutoring system that overcomes these barriers and results in a system that when employed is consistently effective at a high rate of individual learner success. There further exists a need to develop a system that achieves such results in a relatively rapid manner. The present invention accomplishes these goals.

### SUMMARY OF THE INVENTION

The present invention is directed to Learning Kits, referred to herein interchangeably as “Learning Kits, or simply “Kits.” The Kits are useful as a tool for assisting high-need, at risk primary grade learners with learning to read. The Kits are further useful as a tool for assisting at-risk learners with learning subject matter or skills relating to reading comprehension, vocabulary enrichment, language development, phonics and phonemic awareness, and cultural enrichment. The Kits are also useful for teaching other skills, including listening skills, speech, articulation, reading and writing and may include subject matter such as language skills, science, history, social science, mathematics, geography, music and finance.

Learning Kits comprise a collection of tools, supplies, and instructional matter useful for tutoring learners. In one embodiment, the Kit comprises one book but ideally contains two copies of the same book. The Kit further comprises a Kit Instruction Sheet, wherein the tutor is provided with all the necessary instructions for assisting the learner with engaging the entire Kit. The Kit further comprises Activities that exist to strengthen desired skills when performed in conjunction with having the book read to them, as well as in the case of advanced learners, attempting to read the book. The Kit ideally contains four to five Activities. Activities are a novel tool in that they are in game format, are largely self-contained and are designed in some context of the book. Activities comprise an Activity Instruction Sheet, Activity Work Sheets, an Activity Answer Key, and other items necessary for engaging the activity, such as playing cards, graphs, charts, maps and may even include items such as string or pipe cleaners for use in the Activity. The Kit may further comprise Supplemental Materials that further enhance a learner's skills and knowledge base. Supplemental Materials are shortened versions of Activities, whereby they engage the student, but are not necessarily in game format. Examples of Supplemental Materials include learning poetry and vocabulary lists, and a recommended book list for the learner. The Kit may further comprise a Reading Chart or Progress Chart that allows the learner to document progress and enjoy confidence that is realized with success. The contents of the Kit are contained in a container, and an ideal container is a bag that allows for the convenient identification, transportation and storage of the Kits. Kits may be designed to cover skills of any desired subject matter area, and further any level of ability within the subject area. The invention is related to a single Kit, and use of a single Kit has proven effective in itself. It is ideal that numerous different Kits are designed and implemented to target particular skills sought for all levels in any subject matter area.

A method of tutoring has been invented in which a tutor teaches a learner through use of a Learning Kit. As part of the method, a tutor first familiarizes a learner with the subject matter of the book to be read and discusses at least one concept that will be learned in the book. The tutor then reads the book to the learner. For advanced level learners, the learner then reads portions, if not all, of the book to the tutor for assistance with general reading fluidity and with articulation, intonation and inflection. Following reading of the book, the learner engages at least one Activity with the assistance and direction of a tutor. Ideally, the learner engages all Activities in the Kit, each with the assistance and direction of the tutor. Upon completion of the Activities, the learner engages the Supplemental Materials, also with the assistance of the tutor. Finally, the learner documents his or her progress on a Reading Chart or a Progress Chart. While the engagement of one complete Kit has proven effective in achieving results by employing this tutoring method, a learner ideally engages multiple Kits both within his or her academic level as well as all Kits for a particular subject matter area for maximum accomplishment.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify various embodiments of this system and method.

FIG. 1 is an exemplary of the contents of a Learning Kit.

FIG. 2 is an exemplary of a Learning Kit Instruction Sheet.

FIG. 3 is an exemplary of a Learning Kit Activity.

FIG. 4 is an exemplary of the contents of a Learning Kit Instruction Sheet.

### DETAILED DESCRIPTION OF ILLUSTRATED EMBODIMENT

It is known by those affiliated with educational institutions, boards of educations, literacy-based organizations and schools, as well as by teachers and tutors, that there is an alarming need to address reading and learning deficits that face millions of learners, especially those of the primary grades. These students are known as at-risk learners. At-risk learners face such deficits due to a number of factors, including (1) a very limited vocabulary, (2) a poorly developed intellectual foundation at home prior to entering school, (3) little, no or anti-social support for institutional learning once it is implemented, (4) socio-economic constraints for effective learning, (5) poorly-trained and/or ill-performing educators in classrooms, (6) poorly planned curriculum within institutions, and, ultimately, (7) distressingly low reinforcement of positive gains when learners do experience them. The mere presence of learners in school and huge sums of money poured into institutions to counteract these trends present data that is nevertheless increasingly disparate with the continued decline of academic progress for large numbers of learners. Many states have mandated proficiency examinations to address this disparity.

One solution sought to address the needs of children and widely known in the art is tutoring. Tutoring usually involves personalized assistance to at-risk learners outside of the general school hours. These programs or sessions often require the donated time of individuals who may or may not be state qualified instructors, and even if they are, who may lack the particularized skills that a tutor needs in order to adequately address the deficits of an at-risk learner. Many of these tutoring programs, even when well-planned and monitored, are rejected by an at-risk learner who desperately needs a novel approach to retention, i.e. one that complements the classroom but does not duplicate the curriculum that they are inadequately prepared to confront. Often, the programs and sessions find the tutors using drill sheets or computerized programs that do not address or reverse the root problem: a lack of reading fluency. These programs may also be well-designed and coordinated by program administrators and well-funded by private or public institutions. But without the tools and techniques to ensure that academic information that is provided to an at-risk leaner is not only retained but also incorporated into that learner's knowledge base, these Herculean efforts are often futile.

An invention has been conceived and implemented that when employed by a tutor, is highly effective in engaging an at-risk learner. It is theorized that this novel system results in the incorporation of academic subject matter into the working brain of the at-risk learner and development of a solid foundation upon which more and more advanced learning can be assembled. This method has proven highly efficient in individual and group tutoring settings and has seen much success in improving the academic skills of an at risk learner. It is effective for any subject matter, attractive to tutors, warmly received by school administrators and program coordinators, and productive with learners of any age or learning level. It further negates the need for financially and developmentally mammoth efforts to tutor children by and through programs that often result in failure.

The present invention may be embodied in a variety of ways. For example, the present invention may be embodied as a teaching or tutoring tool. In one embodiment, the invention is a kit, or collection of specific items that generate an effective learning system. It is another embodiment that the kit contains specific activities that have not been used in the prior art. In another embodiment, the present invention is method and system that enables an individual learner or groups of learners to more effectively learn subject matter than traditional and known tutoring methods have been able to provide. In another embodiment, the present invention provides for a system of tutoring a particular subject with an emphasis on reading to a learner. The method involves employing a number of items, which when used in combination and in a determined format, generate effective learning of reading skills and other academic subject matter.

In one embodiment, Learning Kits comprise a collection of collection of tools, supplies, and instructional matter useful for tutoring learners. In one embodiment, the Kit comprises one book but ideally contains two copies of the same book. The Kit further comprises a Kit Instruction Sheet, wherein the tutor is provided with all the necessary instructions for assisting the learning with engaging the entire Kit. The Kit further comprises Activities that exist to strengthen desired skill when performed in conjunction with both having the book read to them as well as attempting to read the book. The Kit ideally contains four to five Activities. Activities are a novel tool in that they are in game format, are largely self-contained and are designed in some context of the book. Activities comprise an Activity Instruction Sheet, Activity Work Sheets, an Activity Answer Key, and other items necessary for engaging the activity, such as playing cards, graphs, charts, maps and may even include items such as string or paper clips for use in the Activity. The Kit may further comprise Supplemental Materials that further enhance a learners skills and knowledge base. Supplemental Materials are shortened versions of Activities, whereby they engage the student, but are not necessarily in game format. Examples of Supplemental Materials include learning poetry and vocabulary lists, and being provided with a recommended book list for the learner. The Kit may further comprise a Reading Chart or Progress Chart that allows the learner to document progress and enjoy confidence that is realized with success. The contents of the Kit are contained in a container, and an ideal container is a bag that allows for the convenient identification, transportation and storage of the Kits.

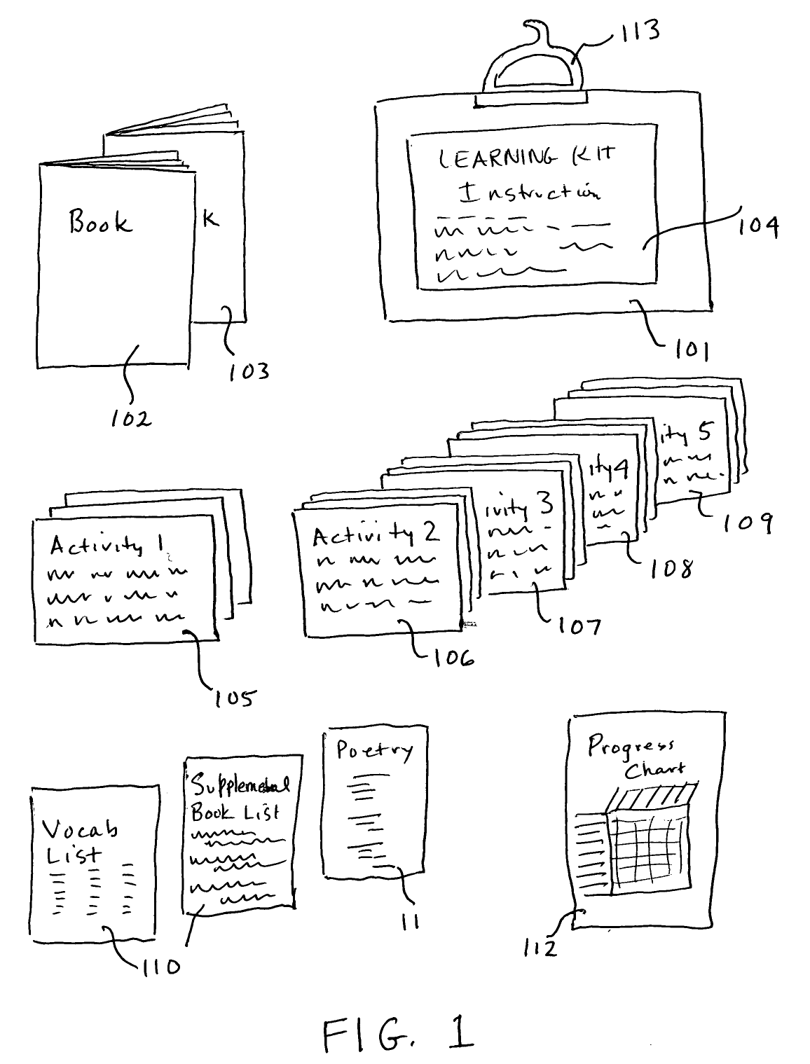

In FIG. 1 there is exemplary of the contents of a Kit. The Kit ideally contains all its materials in a bag 101. A Kit contains a book 102 and may be most effective if the kit contains two of the same book 102 and 103 such that one book may be used by the student and a second may be used by the tutor. The Kit also contains a Kit Instruction Sheet, 104, ideally secured to the inner lining of the transparent Kit bag, for easy identification and viewing. The Kit may also contain least one Activity 105 but ideally contains four to five Activities 105, 106, 107, 108 and 109. The Activities are skill-building activities and the Kit contains Activities of which some portion should be related to the book. An Activity comprises an Activity Instruction Sheet, Activity Work Sheets (also simply herein as “Activity Sheets), an Answer Key and other items more fully disclosed below. Activities may include general or specific activities such as (1) puzzles, such as crossword puzzles, (2) match games, (3) poetry for reading, reciting and or memorization, (4) word games, (5) alphabet games, (6) geographical maps and charts, (7) historical events identification, (8) anagram solving, (9) palindrome identification, (10) grammar studies, including identification, execution and correction, (11) synonyms and antonyms studies, (12) word, idea and concept matching games, (13) punctuation identification, (14) word definition games, (15) scientific charts and graphs, (16) mathematical concepts, (17) character development and the like. It should be appreciated that any suitable form of engaging activity that may be conceptualized for purposes of engagement and learning may be used. The Kit may also contain Supplemental Materials 110 and 111. Supplemental Materials are shorter forms of Activities that are both enjoyable to the learner and help reinforce the major topics that have been covered in the Activities. The Kit may also contain a Reading Chart or a Progress Chart 112.

The contents of a Kit are placed in any suitable container, which is ideally a Bag 101. A Bag may be of any medium, such as cloth, but ideally is a transparent plastic bag. The Bag may be of any suitable size, but is ideally large enough to easily accommodate the 8½ by 11 inch-contents of a Kit. Kit Bags have been designed that are fourteen inches in height by sixteen inches across, but it should be understood that any suitable size may be used. The Bag 101 is secured at the top by a plastic handle 113 secured to top portion of the bag, wherein the handle snaps together for closing and transporting the bag and unsnaps for access to the kit. The handle may also be of a shape that allows for it to be stored by hanging it on a rack. One side of the Bag 101 may contain an extra portion of plastic, which having been secured to the Bag on three sides creates a pouch or pocket wherein a Kit Instruction Sheet 104 is inserted. The Instruction Sheet is ideally printed on a piece of 8½ inches by 11 inches heavy paper and laminated. The Instruction Sheet may be of any size and may be placed within the Kit in any convenient manner. The Instruction Sheet may be color-coded or contain designated symbols or markings for purposes of identification.

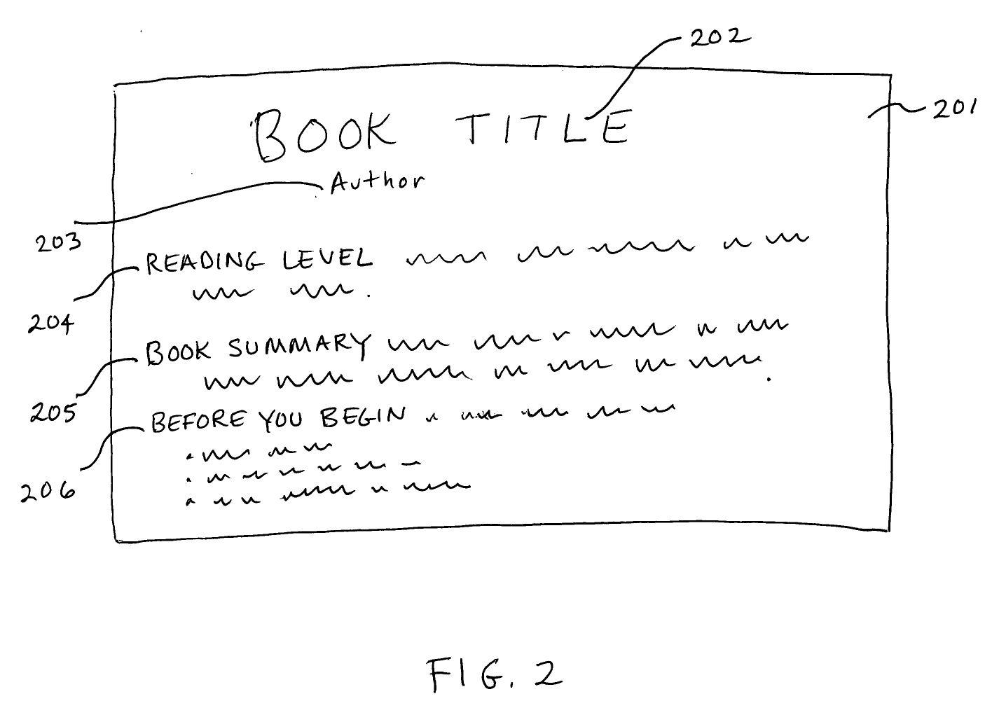

FIG. 2 illustrates an exemplary of a Kit Instruction Sheet 201 secured to the Kit Bag. The Kit Instruction Sheet contains a Book Title 202 easily visible for identification and which identifies the book employed by the Kit. The Book's author is identified below the Title 203. The Kit Instruction Sheet further contains three informational items: the Kit “Reading Level” 204 a “Book Summary” 205 and a “Before You Begin Reading the Book” instruction 206. The Reading Level 204 identifies the level of the Kit, such as Pre-Emergent, Emergent, Developing, Functional, or Independent/Purposeful as described more fully below. The Instruction Sheet is ideally color coded as more fully described below and matches the same color identification as the remaining contents of a Kit, i.e., the Activity Sheets and Supplemental Materials.

In one embodiment of the invention, Kits may focus on a specific area of subject matter. In one exemplar, Kits are designed to align with state department of education standards and thereby target individual subject matter areas such as Reading Comprehension, Vocabulary Enrichment, Language Development, Phonics and Phonemic Awareness, and Cultural Enrichment. It should be appreciated that Kits could be designed for any subject matter. For example, Kits have also been designed to enhance and develop a learner's skills such as Listening Skills, Speech, Articulation, Reading and Writing and may include other subject matter such as Language Skills, Science, History, Social Science, Mathematics, Geography, Music and Finance. The technique may employ a single subject matter but may also combine subject matter, such as the combination of the subject matter Literacy and Mathematics or the combination of History and Geography.

Although the use of one single Kit is a novel approach to learning and sufficient to achieve desirable results unattainable through those systems currently known in the art, Kits have been developed to build on one another and be effective through the use of multiple Kits. For example, there have been developed thirty Kits comprising the subject area of Reading, including: (1) Reading Comprehension, which targets skills such as prediction and foreshadowing, comparing and contrasting of concepts, sequencing of events within a story, categorization of events within a story, story summarization, story retelling, cause and effect of events within the story, and reaching conclusions; (2) Language Development, which targets skills such as punctuation, capitalization, word order, word choice and sentence order; (3) Vocabulary Enrichment which targets skills such as the expansion and enhancement of vocabulary; (4) Phonics and Phonemic Awareness which targets skills such as construction of words and the intonation, articulation, and inflection of words; and (5) Cultural Literacy, which targets skills such as building a cultural foundation common to the educated population. Upon conclusion of each Kit a learner will have mastered each of these skills and will then advance the next level Kit and towards a solid, functional level similar to standards of a person of that age. It should be appreciated that only one Kit is necessary to serve at least some need of an individual learner and that the accomplishment of a learner of just one Kit is sufficient to produce positive results. It has been found that, depending on a learner's starting position and coupled with his or her individual needs, that maximum results are realized from the engagement of all those Kits necessary for a learner's individual needs. It should be further appreciated that depending on the subject matter or the goal of a particular Kit or set of Kits, that any number of Kits may be designed and implemented for productivity. For example, if a learner functions well in math except with respect to long division, a Kit or series of Kits dealing with this targeted skill within the mathematics subject area may be sufficient for this learner in overcoming this skill deficit.

In another embodiment, Kits may be of a particular learning level. Because the purpose of Kits is to tutor learners who are either behind their peers with respect to academic aptitude or who seek to improve in particular subject areas, it follows that Kits may be best prepared to target specific learning levels. For example, in Reading Comprehension, it is well known in the art that there are varying levels of reading skills. It has been discovered that in order for a learner to successfully master one level, the learner must have the opportunity to complete six Kits within a level. This number is not arbitrary, nor is it based on mere repetition, but rather it results from requiring a learner to become comfortable with, if not to master, specific variables within a given level to effectively build a foundation at that level. In the case of the subject area of Reading Comprehension, for example, there are particular skills that must be mastered for a beginning level reader, a developing reader, a functional reader, and so forth.

The Kits are designed to target ability, not age, and fit into the skill categories as follows: Pre-emergent, Emergent, Developing, Functional and Independent/Purposeful. Pre-emergent level Kits are designed for pre-kindergarten learners, that is, those of pre-school ability with very little if any ability to read. While this is very normal for a three, four or five-year old, a second, third or fourth grader who falls into this category is considered an at-risk child. The Pre-Emergent Level Kit is appropriate in tutoring either learner but is most effectively designed and developed for assisting the at risk learner. Pre-Emergent Level Kits are designed to assist those learners who recognize very few words. They are learners who must have a book read to them, have specific concepts explained to them both prior to, during and after the book is read, and require the full participation of the tutor with each Activity in the Kit. Emergent level Kits are designed for those learners who (1) recognize some words, (2) understand stories partially based upon the illustrations they see, and (3) use text cues in assisting the development of the book's story. Developmental level Kits are designed for those learners who (1) are concerned with making sense of sentences rather than focusing on single work accuracy, (2) are able to self-correct their reading mistakes, (3) ask for assistance in reading, (4) use illustrations to predict and confirm the meaning of words, (5) use phonics for unfamiliar words, and (6) are capable of making sense of the overall meaning of series of words if not the whole story. Functional level Kits are designed for learners who (1) are comfortable with simple reading tasks, (2) are aware of how they read, (3) use previewing and predicting reading strategies, (4) monitor reading for clarity, and (5) use context clues to support the meaning of words and phrases. Independent/Purposeful level Kits are designed for learners who (1) adapt their reading approach to fit the reading material, (2) can sustain reading for an extended period of time, (3) understand and recall information accurately, (4) understand relationships between pieces and parts of the story and can thus retell and summarize, and (5) use multiple materials to study a topic. Ideally, a learner works through all Kits within a particular level and then graduates to the next level until all Kits of all levels are accomplished for maximum progress.

As indicated, the Kits are designed to target ability, not age. For example, a leaner may be of a third grade age, but may be at the Pre-Emergent Level. The learner would begin work with Kits of the Pre-Emergent Level, and as he or she realizes success, would progressively move through Kits of this appropriate level, graduate to the next level, and so on until he or she reaches the skill level of his or her actual grade level. It is known in the art that up until the third grade level, a child learns to read. After the third grade a learner reads to learn. The levels of Kits have been designed to facilitate this need and a leaner may commence use of the Kits at any level, regardless of age, until the desired subject matter aptitude or skill level is attained. It should be appreciated that Kits may be developed wherein one could desire any specific gradation of learning level and that any suitable categorization of levels may be applied, such as a numbering system, a grade level system, etc.

Kits have been further designed wherein the skill categories or learning levels are color-coded for purposes of identification by both the learner and tutor as well as for a sense of progress by the learner. Color coding may be accomplished in a number of ways. First, any or all portions of the contents of a Kit can be of a certain color. Pre-emergent Level Kits have been assigned the color lavender. Emergent Level Kits have been assigned the color pink. Developing Level Kits have been assigned the color yellow. Functional Level Kits have been assigned the color green. Independent/Purposeful level Kits have been assigned the color blue. As discussed below, Kits contain Kit Instruction Sheets and Activity Instruction Sheets. Kits have been designed wherein the color coding is accomplished by the Kit Instruction Sheet and Activity Instruction Sheet within a Kit being the color of the Kit Level. When the Kit contents are properly assembled within a Kit bag that is made of clear plastic, the level of the Kit can be clearly and quickly determined by the color of the Kit Instruction Sheet and the Activity Instruction Sheets. It should be appreciated that Kits, whether there are Levels or not, can be of any color or artistic design to effectively cover the invention herein, and visual distinctions and other aesthetic qualities serve to enhance the convenience and attractiveness of the Kits. It should be further appreciated that in addition to or as an alternative to color coding, any visually identifiable marking, such as numbers, symbols, or other forms of identification can be used separately or in addition to color coding to identify different levels of Kits. Finally, the Kit bag itself could be opaque and be of a certain color or contain identifiable markings to effectuate such identification. Finally, it should be appreciated that visual color coding and other markings can be employed not only to distinguish levels, but to differentiate between subject matter of Kits.

Kits have been designed to be effective for tutoring sessions wherein the rate at which a learner meets with a tutor is subject to the known typical constraints of a learner's available time. For example, a learner usually has only a few hours per week to meet with a tutor, and the Kits have proven effective when engaged for that small period of time. It should be understood that without practical time constraints, the Kits are still effective, but it is an advantage of the invention that the Kits are productive for use under limited time constraints. The Kits have been found to be highly productive in tutoring sessions in relatively short periods of time. Kits have been designed wherein six Kits have been assigned to a particular level. Each Kit takes approximately a month for the learner to work through. Ideally, the tutor meets with the learner approximately once a week for one hour a week. The Activities can take from one half hour to one hour to complete. Supplemental Materials can usually be accomplished in fifteen to twenty minutes. At this rate, it takes approximately three to four months for a learner to accomplish a particular level. Under this scenario, a learner can commence use of the Kits with extremely limited ability and find him or herself to be a functional reader, that is, having worked through four of the five levels, in seven to eight months.

It is a novel feature of the Invention to employ Activities that are (1) in game format, (2) self-contained and (3) are designed in the context of the Kit's book. Activities need not posses all three characteristics, but it has been found that a combination of at least two of these features, such as an Activity being in game format and self-contained, distinguishes them from those forms of known Activities. In the field of education, activities are used to engage a learner with some intellectual concept to achieve some educational result such as answering questions, matching concepts, etc., based on information the learner has previously learned. Activities of the invention improve over those known in the field. First, Activities are in a game format, and this particular feature has not been employed in the prior art. The game format of an Activity requires at least one feature of (1) skill (applying knowledge, practice and aptitude), (2) concentration (development of concepts applicable to the subject matter of the Kit and/or its specific book), (3) strategy, (4) adherence to rules and (5) competition (for those Activities done by two or more learners). Activities are not ideally in the form of chance or luck but are best suited for a learner to achieve success based on the aforementioned game characteristics. Activities can be in the form of a game whereby a learner engages the Activity by him or herself or with other learners, and in either case, the Activity ideally is done in the presence and supervision of a tutor who may assist learners as they participate in the Activity.

Second, the Activities are largely, if not completely, self-contained. It is known in the art that activities that follow a learner's reading of a book are most productive in strengthening desirable academic skills. However, those known in the art are of the type that merely suggest some follow-up activities and require the participant or tutor to procure or generate those components that would be required to engage the activity. Activities of the Kit described herein have been developed whereby all the parts and pieces necessary for the Activity are contained in the Kits. An Activity that requires generally accessible items, such as pens, crayons, or scissors should not be considered to render an Activity not self-containing, as such items are likely to be readily available in classroom settings or tutoring environments. The self-containing nature of the Activities over the prior art is that all the major features of an Activity, such as graphs, charts, playing cards, and other likely inaccessible items are present. Consequently, Activities of the invention however are self-contained or largely self-contained, i.e. all elements of the Activity are contained in the Kit, such as instruction sheets, work sheets, reference charts, maps, graphs, game pieces, flash cards, playing cards, and other needed items such as string or pipe cleaners. For some Activities, an additional external item, such as scissors, or a photocopy machine may be required, but the very limited need for these items do not detract from this novel feature of the Activity. It has been discovered that Activities that are self-contained or largely self-contained are highly successful tutoring tools. It is theorized that the success results from many factors including general convenience, the lack of time wasted to procure activities formerly used in the art, and full concentration and emphasis on engaging the activity as opposed to assembling or creating it.

Third, the Activities may be designed in the context of the book contained in the Learning Kit. The contextual relation of an Activity to the book may be by general concrete subject matter, such as the story's characters, location, or setting, as well as abstract subject matter such as intended themes, principles, morals, or values. There may further be a contextual relation of an Activity to the book wherein the book contains words, and phrases that are useful for purposes of an Activity that, for example, employs language development, as in the case of synonyms, homonyms, antonyms, rhyming, punctuation, parts of speech, and the like. Thus, Activities are not random, but are designed to refer to numerous concepts found in the book and require or promote additional reading and referencing of the book for success. For example, there has been designed an Activity designed within a Kit that employs the book The Snowy Day by Ezra Jack Keats. The Activity a game entitled “Go Ice Fish” wherein playing cards indicate activities that children can accomplish on snowy days. The learners are required to read the snow day activities and determine whether those activities were done by the main character in the Kit's book. The contextual nature in this Activity refers to the snowy environment to the book. Not all Activities in a Kit are required to have this contextually related feature, but is has been found that if at least most of the Activities of a Kit have some contextual connection to the Kit's book, such as by subject matter, word usage, geographical similarity, or other conceptual connection, that development of aptitude in the subject matter is greatly enhanced.

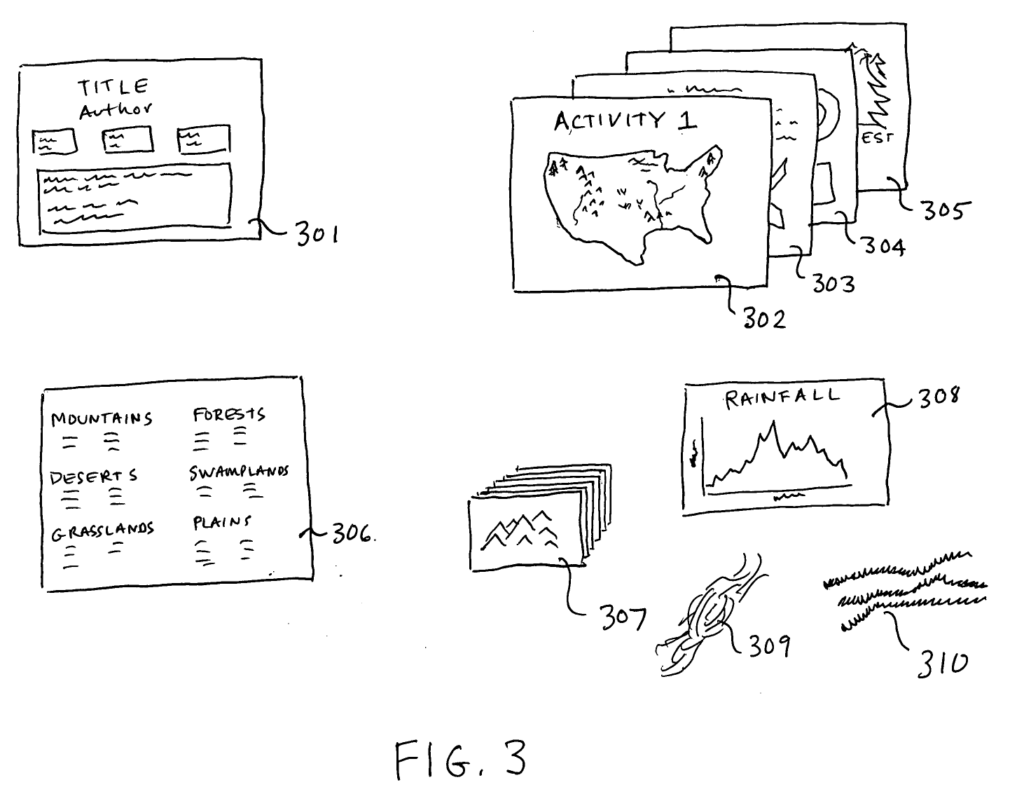

FIG. 3 is an illustrated exemplary of an Activity. An Activity comprises an Activity Instruction Sheet 301, Activity Work Sheets 302, 303, 304 and 305, an Activity Answer Key 306 and other possibly necessary items such as Playing Cards 307, puzzle pieces, or any conceivable item such as puzzle grids, photographs, charts, graphs, maps for making the Activity functional and self contained. The Activity may further contain such necessary items such as string 309 pipe cleaners 310 and the like, and these smaller, loose items may themselves be contained in a small container, such as a clear plastic bag for keeping them contained.

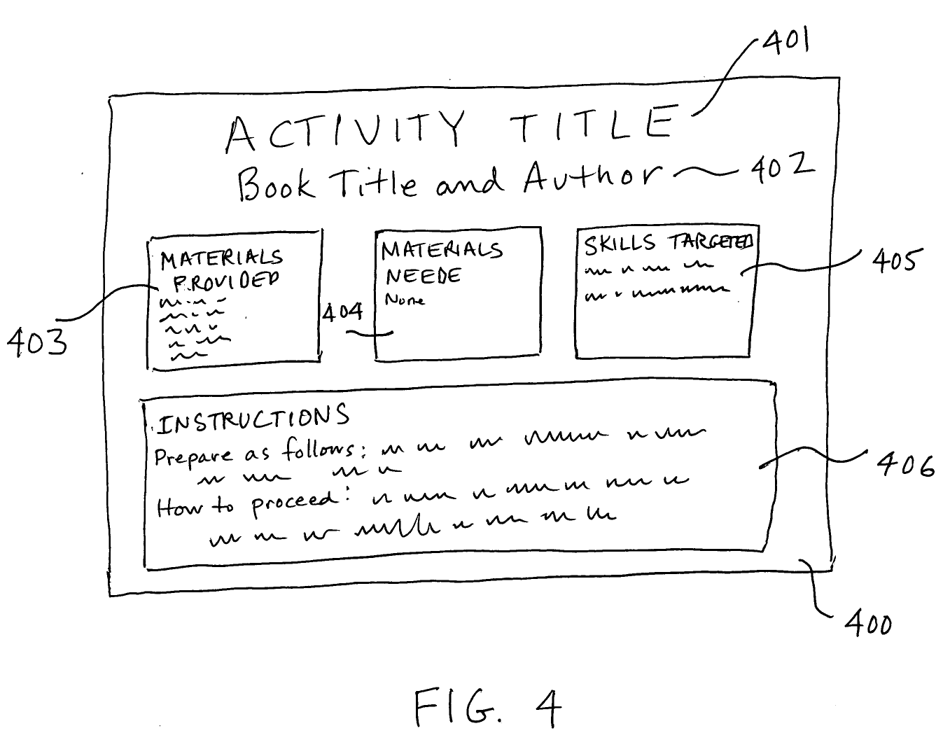

FIG. 4 is an illustrated exemplary of the Activity Instruction Sheet. The Activity Instruction Sheet 400 can be of any size, but is ideally 8½ by 11 inches. It may be laminated for protection and the Activity Instruction Sheet 400 may be color coded, such as pink for a lower level and green for a higher level as discussed above. The Activity Instruction Sheet contains a title 401 that describes the nature of the Activity, such as “Activity One: Synonyms and Antonyms.” Underneath the title, a reference 402 to the book and author contained within the Kit is indicated. The Activity Instruction Sheet may also indicate which materials are provided for the Activity under the heading “Materials Provided” 403 and may indicate those materials as the Kit's book, Activity Work Sheets, cards, such as game cards, and an Answer Key. Materials may also include objects such as puzzle grids, photographs, charts, graphs, maps or any conceivable objects that may be needed and supplied for the Activity. The Activity Instruction Sheet may also contain materials that may be additionally needed for the activity under the heading “Materials Needed,” 404, such as paper, scissors, glue, tape, crayons, pens or pencils, dictionary, encyclopedia, or other reference book. In many cases, the Materials Needed will indicate “none” for Activities that are entirely self-contained. An Activity that requires generally accessible items, such as pens, crayons, or scissors should not be considered to render an Activity not self-containing, as such items are likely to be readily available in classroom settings or tutoring environments. The Activity Instruction Sheet may also contain a reference to the particular skill or skills being targeted under the heading “Skills Targeted” 405. The Activity Instruction Sheet also contains a section providing directions for completing the Activity under the heading “Directions” 406. The Directions 406 assist the tutor and the learner in completing the Activity and provide clear and simple instructions and recommendations for making the Activity most effective.

Following are examples of Activities, including Activities such as word games, word puzzles, parts of speech, rhyming, spelling, word meaning and pronunciation, compound words, graphs, cause and effect, and punctuation activities. It should be appreciated than any types of Activities may be effective and those provided are for purpose of example.

An example of an Activity wherein the Activity is a word game is as follows, and this particular activity comes from a Kit targeting Phonics and Phonemic Awareness. The Activity is entitled “Listen for S” and comes from a Kit wherein the book is Who's Hiding? by Susan Canizares and Pamela Chanko. The Activity Instruction Sheet identifies this book under its title. The Activity Instruction Sheet indicates Materials Provided as “4 Listen for S Cards,” “Activity 1 Answer Key” and “4 pipe cleaners.” The Activity contains an Activity Work Sheet, which is 8½ by 11 inches and laminated and has a picture of a sinusoidal snake with the words “Beginning” and the front of the snake by the snake's head, “Middle” at the middle of the snake and “End” at the end of the snake. The Activity also contains an Activity Answer Key. The Answer Key contains a list of words under the heading “Beginning” and those words are “school, square, salt, Scotland, sun, smile, sign, sleep, soft, spinach” and are essentially words that contain the “s” sound at the beginning of the word. The Answer Key further contains a list of words under the heading “Middle” and those words are “castle, preschool, rooster, opossum, crystal, mustard, muscle, insect, handstand, gasoline” and are essentially words that contain the “s” sound in the middle of the word. The Answer Key further contains a list of words under heading “End” and those words are “address, grass dress, kiss, bus, nurse, mess, house, kittens, loose” and are essentially words that contain the “s” sound at the end of the word. It should be understood that words other than those used in this particular activity could be used as part of the invention. The Activity Instruction Sheet contains instructions as follows: “Hand out one ‘Listen for S Sheet’ and one pipe cleaner to each child. Help the children form a letter ‘s’ with the pipe cleaners so that the ‘s’ looks like a snake. Make the ‘s’ sound for the children by imitating the sound of a snake: ‘hisssss.’ Pick a word with the beginning ‘s’ sound from the “Listen for S Answer Key” and read it to the group. Tell the children to place their pipe cleaners on the snake to show where the ‘s’ sound occurred in that word (at the beginning of the word at the head, at the end of the word at the tail, or in the middle.) Repeat this process with an example for the middle and end columns. Now you're ready to begin. Be sure to mix up the words so that the ‘s’ occurs in the beginning, middle and end of the word. Have the children think of other ‘s’ words at the beginning, middle and end.” When a learner participates in this Activity and look up new “s” words in the designated book, his or her reading comprehension ability has been shown to substantially increase both by this Activity alone and even more so when in conjunction with other Activities in the Kit.

In yet another example of an Activity, wherein the activity is a word puzzle, the Activity is as follows, this particular Activity targets language development. The Activity is entitled “Sentence Scramble” and comes from a Kit wherein the book is Who's Hiding? by Susan Canizares and Pamela Chanko. The Activity Instruction Sheet identifies this book under its title. The Activity Instruction Sheet indicates Materials Provided as “Sentence Scramble Puzzle Grid,” “25 Sentence Scramble Word Cards” and a “Sentence Scramble Answer Key.” The Activity contains an Activity Work Sheet and has a grid comprised of five by five squares for a total of twenty-five squares. The Activity also contains an Activity Answer Key. The Answer Key, similarly to the Activity Work Sheet, contains a grid comprised of five by five squares for a total of twenty-five squares but each square contains a word. For example the first column contains the singular or plural nouns, Sam, Sally, Snakes, Sofia, Steve.” The second column contains the singular or plural verbs “sits, sings, slither, smiles, eats.” The third column contains the prepositions or adjectives, “in, a, in, at, some.” The fourth column contains the adjectives or articles “the, silly, the, the, sweet.” And finally the fifth column contains the nouns, “sand, song, grass, seal, berries.” It should be understood that words other than those used in this particular Activity could be used and still be within the spirit of the invention. The Activity Instruction Sheet contains instructions for the Activity, and those directions for this example of an Activity are for the tutor to “Hand out the 25 Sentence Scramble Word Cars as evenly as possible to the children. Ask the children to place their cards face up in front of them. Slowly read the first sentence from the Sentence Scramble Answer Key. This will give the children an idea of what to look for. Reread each word and pause to allow the group to figure out who has that card. The child who has the word, “Sam” places it in the first block of the Sentence Scramble Puzzle Grid. Continue playing until all sentences are filled in. Remind the children that capital letters go at the beginning of sentences and periods at the end. Read the sentences together aloud.” Upon following these instructions, learners create any number of sentences and begin to identify the necessary form and components of a complete sentence. When a learner participates in this activity after having read the designated book, his or her language skills have been shown to substantially increase both by this Activity alone and even more so when in conjunction with other Activities in the Kit.

In yet another example of an Activity, wherein the Activity is directed toward pronunciation and word meaning, the Activity is as follows, and this particular Activity comes from an advanced level Kit that targets vocabulary enrichment. The Activity is entitled “Homonym Hunt” and comes from a Kit wherein the book is Brining the Rain to Kapiti Plain by Verna Aardema. The Activity Instruction Sheet identifies this book under its title. The Activity Instruction Sheet indicates Materials Provided as “24 Playing Cards,” “Answer Key,” and the book, “Bringing in the Rain to Kapiti Plain.” The Activity contains playing cards which contain each a single homonym, such as “to/too,” “plain/plane,” “rain/reign,” “whether/weather,” and “heard/herd.” Learners play a game in which they collect a pair of homonyms and learn to describe their differences. Each of the homonyms is contained in the book and referral can be made to the book for identification of a homonym's meaning. In the second part of the Activity, learners are given playing cards wherein there are two incomplete sentences with a single word missing, and these sentences are taken from the book Bringing the Rain to Kapiti Plain. An Example of one playing card contains the following two sentences: “It fell near Kipat, who watched his ______” and “As he stood on one leg, like the big stork ______” and the students are required to select from a list of words to match the rhyme, which in this particular activity would be “herd” and “bird” respectively. When a learner participates in this Activity after having read the designated book, his or her ability to understand sound and rhymes has been shown to substantially increase both by this Activity alone and even more so when in conjunction with other Activities in the Kit.

In yet another example of an Activity, wherein the Activity is a spelling game, the Activity is as follows, and this particular Activity comes from a Kit that teaches vocabulary development. The Activity is entitled “Braille Spelling” and is a spelling exercise. The Activity comes from a middle level Kit wherein the book is Seven Blind Mice by Ed Young. The Activity Instruction Sheet identifies this book under its title. The Activity Instruction Sheet indicates Materials Provided as “Master Copy: Braille Letter Cards,” “Master Copy Braille Alphabet,” and “Braille Word Guide.” The Activity contains an Activity Work Sheet which has a the complete Braille alphabet, Braille numbers, and Braille punctuation marks. The Activity also contains an Activity Work Sheet containing a series of words. The Activity Instruction Sheet provides instructions stating “Hand out the photocopies of the Braille Letter Cards. Have the students cut out their own set of 34 cards. Using the Braille Word Guide, the tutor will read a word form the story aloud and the students will use their cards to spell the word. Students may use Seven Blind Mice to verify the correct spelling after they have arranged their cards.” When a learner participates in this Activity after having read the designated book, his or her vocabulary development has been shown to substantially increase both by this activity alone and even more so when in conjunction with other Activities in the Kit.

In yet another example of an Activity, wherein the activity is a compound word game, the Activity is as follows, and this particular activity comes from a Kit that also teaches vocabulary development. The Activity is entitled “Go Ice Fish” and comes from a middle level Kit wherein the book is The Snowy Day by Ezra jack Keats. The Activity Instruction Sheet identifies this book under its title. The Activity Instruction Sheet indicates Materials Provided as “18 Go Ice Fish Cards,” and a “Compound Word Grid Master.” The tutor prepares the learners for the game by explaining the meaning of a compound word as a word being made up of two smaller words and providing examples. The tutor then draws the first card and the card contains a compound word such as “snowmobile.” The tutor indicates the two separate words, defines them, repeats the compound word and defines that word. Learners then take turns drawing cards and proceeding similarly by defining the individual smaller word and then the larger compound word. When a learner participates in this activity after having read the designated book, his or her reading vocabulary development has been shown to substantially increase both by this activity alone and even more so when in conjunction with other Activities in the Kit.

In yet another example of an Activity, wherein the activity is a snowfall graph, the Activity is as follows, and this particular activity also comes from a middle level Kit that targets map reading a graph comprehension. The Activity is entitled “Go Ice Fish” and comes from a Kit wherein the book is The Snowy Day by Ezra jack Keats. The Activity Instruction Sheet identifies this book under its title. The Activity Instruction Sheet indicates Materials Provided as “4 Snow Graph Cards,” “68 Snowflake Cards,” “4 Sets of State Cards,” “Master Copy of U.S. Map,” and a “U.S. Map Answer Key.” The Activity Instruction Sheet contains Preparation Instructions for the tutor to read as follows: “Explain that graphs help us compare information. In this activity, students compare snowfall in four states of their choice in two different rounds of play. Hand out copies of the U.S. Map and a Snow Graph Card. Explain that the graph has an axis on the bottom (States Axis) and an axis on the side (Inches of Snow Axis). Place a set of four State Cards face up on the table. Have students use the snowflake cards, where one snowflake card equals one inch of snowfall, to build a graph comparing snowfall in the four states they have chosen to compare. Have students identify the location of the four states they have chosen on a photocopied U.S. map and have them color in the chosen states in different colors.” When a learner participates in this activity after having read the designated book, he or she learns the value and use of a graph, a beginning understanding of Unites States geography, and scientific assessment of geologic activity such as snowfall. It has been found that Activities of this nature not only build these necessary skills but further enhance a learner's appreciation for concepts he or she may elicit from reading a book.

In yet another example of an Activity, wherein the activity is a cause and effect game, the activity is as follows, and this particular activity targets reading comprehension. The Activity is entitled “The Domino Effect” and comes from a Kit wherein the book is Why Mosquitos Buzz in People's Ears by Verna Aardema. The Activity Instruction Sheet identifies this book under its title. The Activity Instruction Sheet indicates Materials Provided as “12 Event Cards,” and “Answer Key.” The Activity Instruction Sheet contains Preparation Instructions wherein the tutor explains the domino effect, i.e. when dominoes are lined up close enough to one another and one falls, its fall will effect a neighboring domino and so on. The tutor then distributes the event cards evenly to the learners. The event cards are playing cards wherein some event from the story is written on the card such as “King Lion calls a meeting of all the animals. They learn that Mosquito started all the trouble with her lie.” After having read the book, learners take turns submitting events cards based on which event comes first, second, etc. and form a chain of cause and effect on the playing board for events that have occurred in the story. Learners are encouraged to describe how each event has an effect on generating a subsequent event. An Activity Answer Key allows a tutor to assist learners in setting up the order of the event cards correctly. When learners participate in this activity after having read the designated book, they develop not only a temporal relationship between events, but an appreciation for any number of possible events that result from a single initial event. It has been found that Activities of this nature greatly develop a learner's cognition of and appreciation for any given described event and results in the learner developing skills of foreshadowing and potential consequence of a story's events.

In yet another example of an Activity, wherein the activity is a punctuation game, the Activity is as follows, and this particular Activity targets language development and cultural literacy. The Activity is entitled “Capitalization Capture” and comes from a Kit wherein the book is Why Mosquitoes Buzz in People's Ears by Verna Aardema. The Activity Instruction Sheet identifies this book under its title. The Activity Instruction Sheet indicates Materials Provided as “48 Word Card Pairs” wherein there are twenty-four capitalized proper nouns and twenty-four non-capitalized common nouns, and a “Map of Africa.” The Activity Instruction Sheet contains Preparation Instructions wherein the tutor provides the learner with a detailed explanation of the principal of capitalization between proper and common nouns. The proper nouns all represent places that may be found of the map of Africa, whereas the common nouns may refer to Africa but are not identified on the map. The tutor distributes the forty-eight playing cards to the learners. Using a map of Africa learners take turns submitting a card and either placing it on the map of Africa in the correct spot and describing why he or she believes it to be capitalized or places it off the map and giving a similar explanation. As with other Activities, this Activity requires recall from reading the book. When learners participate in this activity after having read the designated book, they are able to place meanings of the story in context, learn capitalization skills, and learn a sense of geography with respect to the country of Africa.

The preceding examples of Activities that come from Kits directed towards Reading Comprehension, Language Development, Vocabulary Development, Cultural Literacy and the like, are provided to give an exemplary of Activities that can be used to strengthen reading fluency. The Activities further provide learners with a broad learning base that is not restricted to the simple reading of words but instead cultivates a richness of words and ideas that greatly strengthen reading skills. It has been further found that the Activities provide a deeper ability of and appreciation for reading that does not wane, but instead creates a solid foundation for reading for pleasure. It should be appreciated that any type of activity may be developed other than those provided in the examples that serves a similar purpose. Any Activity developed that is in game format, is largely self-contained, and is within the context of the book, or at least some combination thereof, is within the spirit of the invention.

In yet another embodiment, the subject matter of a Kit may be mathematics, and there is a Mathematics Kit containing the contents of a Kit, including Activities, as described herein. In one exemplar of a Kit directed towards advanced level learners, there is a mathematics Kit that contains two copies of the book Great Estimations by Bruce Goldstone. The Kit contains Activities, such as flashcards and story problems. In one Activity, there is an Activity Work Sheet wherein the Sheet contains a series of numbers, and those numbers are a selection of twenty numbers from 0 to 100. The Activity also contains sets of playing cards, or flash cards with operations, where one set is addition, a second set is subtraction, a third set is multiplication and a fourth set is division. The learner participates in solving the operations on the playing cards, and upon completing the operation attempts to match the operation's answer with one of the potential answers on the Answer Sheet in order to score points. As part of a group or individual instructional game, learners, after reading the book to comprehend the relationship of numbers, improve their math ability through engagement in one or all of the Activities in the Kit.

In another embodiment, the subject matter of a Kit may be a combination of subject matter, such as both Mathematics and Science and there is a Mathematics and Science Kit containing the contents of a Kit, including Activities, as described herein. In one exemplar of a Kit directed toward advanced level learners, there is a combination Kit that contains two copies of the book Life Story by Virginia Lee Burton. The Kit contains a series of Activities. In one Activity, there is an Activity Work Sheet wherein the Sheet contains a series of three columns. In the first column are listed Geological Periods as follows: Permian, Carboniferous, Pennsylvanian, Mississippian, Devonian, Silurian, Ordovician, Cambrian, and Tommotian.” In the second column are listed Time Periods, in Millions of Years Ago as follows: “286 to 245, 360 to 286, 325 to 286, 360 to 325, 410 to 360, 440 to 410, 500 to 440, 544 to 500 and 530 to 527.” In the third column are listed Specific Life Forms and are as follows: “Brachiopods, Trilobites, Cephalopods, Mosses and Liverworts, Ferns, Insects and Amphibians, Plateosaurus, Stegosaurus and Tyrannosaurus.” In engaging the Activity, after having first read the book, learners are instructed to match items in Columns 1, 2 and 3, and may use the book for assistance. In another Activity in the Kit containing the book Life Story by Virginia Lee Burton, learners participate in the addition and subtraction of large numbers, that is those in the hundred thousands, millions and billions, to improve a learner's appreciation of numbers of substantial magnitude. It has been found that learners who engage in these Activities improve their skills in science and math.

A Kit may also contain shorter Supplemental Materials, and these items are shorter forms of Activities that may be done to further enhance the aptitude of the learner. Supplemental Materials provide additional academic exploration that are similar to activities in that they relate some context of the book, but are not necessarily in game format. Supplemental Materials have been developed that are in the form of (1) poetry (2) vocabulary lists, and (3) a suggested reading list. Supplemental Materials have been shown to be useful in further enhancing learning and encouraging learners to contemplate and appreciate the knowledge and information available to them.

An example of a single Supplemental Material is as follows, and this particular Supplemental Material comes from a Kit wherein the book is Who's Hiding? by Susan Canizares and Pamela Chanko. The Activity Instruction Sheet consists of instructions and information regarding the use of poetry as a “way to expand a child's vocabulary, teach literary techniques, such as rhyming and repetition, and expand cultural literacy.” This particular Supplemental Material contains the poem Hiding by Dorothy Aldis. The instructions direct the teacher/tutor to read the poem aloud, have the learners take turns reciting the poem and even encourage them to memorize and recite parts from memory.

It is another aspect of the invention that a Kit may contain, in the case of Kits directed to the academic subject matter reading comprehension, a Reading Chart. The Reading Chart ideally includes a title, such as for example, “My Reading Chart” and a Grid. The Grid has a horizontal section labeled, “Title of Book” wherein each time a learner completes a Kit, he or she indicates the title of the book. The Reading Chart also includes a vertical section labeled “Kind of Book,” and may include titles such as “Adventure,” “Mystery,” “Around the World,” “Autobiography/Biography,” “Fairy Tail,” “Fiction,” “How to . . . ,” “Humor,” “Fable/Folk Tale,” “Mythology,” “Nonfiction,” Poetry,” “Rhyme/Repetition,” and/or “Sports.” It has been found that a personalized reading chart, in addition to participation of learning with the Activities and Supplemental Materials in a Kit, personalizes the process and reinforces a learner's progress with the Kits, thereby encouraging continued academic growth. It will be appreciated that Reading Charts can be developed with any acceptable or applicable format, and the type suggested is merely a representation of one type of Reading Chart.

In the case of the academic subject matter other than reading comprehension, there may be a Progress Chart, which is synonymous to the Reading Chart previously described. In the case of Kits of the subject matter of Mathematics, for example, there may be a Progress Chart that includes the horizontal section labeled “Math Drill,” and may include drills such as simple written operations, complex written operations, and story problems. The Progress Chart may further include a vertical section labeled “Type of Math” and may include titles such as “Addition,” “Subtraction,” “Multiplication,” “Division,” and “Algebra.” It should be appreciated that Progress Charts can be developed for academic subject matter with any conceivable format, and that suggested is merely a representation of a type of Progress Chart.

The following is an exemplary of the entire contents of a single Kit, and in this example, the Kit is a “Functional Level Kit.” There are the contents of a Kit, including: (1) a Kit Instruction Sheet; (2) two copies of a book, Ming Lo Moves the Mountain by Arnold Lobel; (3) Four Activities, each of which includes an Activity Instruction Sheet, Activity Work Sheets, an Activity Answer Key, and supporting Activity pieces, such as playing cards; (4) three Supplemental Materials; and (5) a Reading Chart. Examples of Activities and Supplemental Materials for this one particular Kit are as follows.

In the first Activity, which is part of the continuing exemplary of an entire Kit, the Learner engages the concept of synonyms and antonyms many of which are found in or refer to concepts in the book. In the first part of the Activity, the learner and tutor engage in a discussion about synonyms and antonyms. In the second part of the Activity, a concentration/match game with paired playing cards are used by first shuffling and then arranging them word side-down on a surface such as a table. Instead of matching identical pairs in the traditional matching game, learners attempt to make a match by choosing cards from the table. A pair is achieved when the learner chooses two synonyms such as “large” and “vast” and antonyms such as “bottom” and “summit.” The player with the most pairs of synonyms and/or antonyms wins the game. The game can be accomplished by using both synonyms and antonyms together as described, but should first be used by using both synonyms first, then antonyms, and finally a mix of both.

In the second Activity, which is part of the continuing exemplary an entire Kit, the Learner participates in learning Chinese proverbs and this Activity is within the context of the book. First the tutor explains a proverb. Second, the learners lay playing cards, which contain Chinese proverbs on one side of the card, face down on a surface, such as a table. Learners take turns turning over the playing cards and reciting the proverbs. The learner then explains what he or she believes the proverb to mean. A proverb key, or Answer Key, is then used to compare the answer with the correct meaning of the proverb. On a separate Activity page, the learner is given the opportunity to create his or her own proverbs and read them to the tutor or group.

In the third Activity, which is part of the continuing exemplary of an entire Kit, the Learner participates in learning geography, which refers to concepts found in the book. The learners are given copies of an Activity Sheet containing the seven contents of the earth wherein various mountain ranges on the Sheet are identified by a number. They are then provided with playing cards wherein a particular mountain range, such as Himalayas and Andes, is identified on one side of the playing card. Learners take turns placing the playing card with the specific mountain range, after pronouncing the range, on the correct location on the map. The learner is guided by an Activity Work Sheet that provides some clue of the mountain range's location, such as India or South America. The learner, once correct, may glue the playing card to the map, thus generating a geographical map containing the major mountain ranges.

In the fourth Activity in the Kit, which is part of the continuing exemplary of an entire Kit, the Learner participates in learning Tangrams, which are Chinese puzzles consisting of a square cut into five triangles, a square, and a rhomboid, to be reassembled into different figures. The leaner is given a master copy of those shapes, which the learner cuts out and rearranges by placing the shapes in the appropriate location one of five Activity Work Sheets that contain pre-formatted shapes. The learner must guess what object the pre-formatted shape is once the puzzle is complete. An Answer Key assists the tutor and learner with determining the correct answers. Upon completion, the learner is encouraged to create his or her own shape using the Tangram pieces.

Continuing with the exemplary of the contents of an entire Kit, the Kit contains Supplemental Materials, and the first Supplemental Material of this Kit involves reading the poem Afternoon on a Hill by Edna St. Vincent Millay. The poem is first read to the learners by the tutor and then read by the learners. Learners are asked to discuss what they think the poem means. They are encouraged to look up words in the dictionary that they do not know. Finally, the learners are asked to read parts of the poem and to memorize some or all of the poem.

In a second Supplemental Material of the Kit, which is part of the continuing exemplary of the contents of an entire Kit, there is a list of fifty vocabulary words that a reader of functional level should know. Learners take turns reading a word and providing a definition. Dictionaries may be consulted for any word the learner does not know. A learner should be able to describe the meaning of almost all of the words on the list.

In a third Supplemental Material of the Kit, which is part of the continuing exemplary of an entire Kit, a list of three additional books of similar reading level and similar literary style are given to learners so that they may take the list for their personal reference. Learners are encouraged to obtain these books from the library and have a family member read the book to them.

Further contained in the Kit, which is part of the continuing exemplary of an entire Kit, is a Reading Chart. The Reading Chart allows the learner to add the book Ming Lo Moves the Mountain to the list of books the learner has read and to indicate the type of book, such as fairy tale, autobiography, nonfiction, etc., on the chart. The learner provides his or her name, and the tutor indicates the book has been read and the Kit accomplished.

In another embodiment of the invention, a novel method has been invented to effectively and successfully assist learners in becoming functional and independent readers, even if a learner commences instruction with little or no reading ability. This same method may also be employed for teaching learners any desirable subject matter, such as, for example, science, geography and math. The method comprises the employment of the Learning Kit described herein, whereby a tutor assists a learner in learning reading skills or other academic subject matter. The method of employing the Kit comprises a tutor utilizing the Kit Instruction Sheet, reading the Kit's book to the learner or learners, and assisting learners in engaging the Activities in the Learning Kit. The method may also include the tutor's assistance to learners in engaging the Supplemental Materials in the Kit and having learners complete the Reading Chart or the Progress Chart.

Ideally, the method is employed whereby a tutor uses a Learning Kit as described herein. The tutor first engages the learner by discussing the contents of the book and that which the learner is likely to learn. The learner then listens to the tutor read the book and the learner may attempt to read along while the book is read. For more advanced levels, the method may involve the learner reading the book independently and audibly for the purpose of practicing (1) reading and (2) intonation, articulation and inflection skills. The learner then engages at least one Activity, but ideally all four or five Activities either by him or herself or with a group of learners and this engagement is done under the supervision and by the assistance and active participation of the tutor. Once all the activities of a Kit are accomplished, the tutor then engages the learner in at least one Supplemental Material but ideally all three Supplemental Materials. Like the Activities, the Supplemental Materials require open and active participation of both the learner and the tutor for a desirable result. Upon completion of the entire Kit, the learner documents his or her progress on the Progress Chart or Reading Chart.

Learning Kits as described herein have been developed and reduced to practice in a number of learning institutions. Those who have employed the Learning Kits have indicated that learners show a markedly higher learning retention rate than through the use of traditional tutoring materials. Tutors have further indicated that the Activities cover the necessary skills mastery for all levels and that learners' propensity to read books greatly increases after use of the Kits. Tutors who have used the Learning Kits have indicated that the self-containing nature of the Activities has made them highly convenient and a productive tutoring tool. Tutors who have used the Learning Kits have further indicated that the Kits have assisted them in areas where they would otherwise be inadequate in tutoring particular skills. It has also been shown that at-risk learners can be quickly and effectively taught such that they may progress to the point in which they are of equal or similar academic performance as their peers.

Kits may be developed, designed and prepared as follows. Books containing particular subject matter are analyzed and identified as being useful for a particular area of instruction. For example, a book may be valuable for reading comprehension, and may further contain, for example, geographical terminology, such as rivers, lakes, mountains, fiords, etc. A series of Activities may then be developed that focus on a number of skill building areas, all of which refer or have some connection to the book. To continue with the above example, a kit may have a first activity that involves identifying particular geographical terms on a graph, and at least some of those terms can be found in the book. A second activity can be designed in which a grammar skill is practiced, and, for example, if the book may be rich in action verbs, an Activity relating to such verbs may be developed. A third activity may be designed wherein some form of cultural literacy is targeted, such as an exploration of terms and concepts that might be part of a particular culture, and the book would likely have references to such a culture. A fourth activity might be developed wherein the goal of the Activity is to practice matching synonyms and at least one word of the synonymic pair is found in the book. Each Activity is designed in a game format. Games may be as described elsewhere herein, such as puzzles, card games, charts, graphs and the like. All materials needed for participation in an Activity are prepared, such as instructions, work sheets, charts, graphs, reference sheets, game pieces, and the like. Supplemental materials, which are shortened versions of activities, may also be prepared. Such material may include a poem that contains some literary content consistent with the book as well as a vocabulary list of words that should be practiced and learned by the learner. Supplemental Materials may also be prepared that include a suggested reading list. Each the poem, the vocabulary lists and the suggested reading lists should be of a skill level consistent with that of the book. A reading or progress chart may also be designed in such fashion that it allows the learner to chart his or her progress by completing each Learning Kit. The contents of a Kit may then be secured in any useful container, and a transparent bag containing the items is ideal. The Kit may also be identified, and instructions for the kit provided, on a Kit Instruction Sheet that is readily identifiable and useable by placing it on the outside of the bag or otherwise made readily available. Any form of identification of a Kit may be preferred and accomplished. It should be appreciated that any variation of the generation and assembly of a Learning Kit described herein may be employed to achieve the desired results.

I claim:

1. A learning kit for tutoring learners comprising:
at least one copy of a book; and
at least one activity wherein at least one activity is in game format and is self-contained.

2. The learning kit of claim 1, wherein the learning kit further comprises a container.

3. The container of claim 2, wherein the container is a bag.

4. The learning kit of claim 1, wherein the learning kit further comprises an instruction sheet.

5. The learning kit of claim 1, wherein at least one activity employs a poem or a vocabulary list.

6. The learning kit of claim 1, wherein the learning kit further comprises a progress chart.

7. The activity of claim 1, wherein the activity is contextually related to the book of claim 1.

8. The activity of claim 1, wherein the activity further comprises:
an activity instruction sheet;
at least one activity work sheet; and
an activity answer key.

9. The activity of claim 8, wherein the activity is contextually related to the book of claim 1.

10. The activity of claim 8, wherein the activity further comprises a set of game cards.

11. The activity of claim 8, wherein the activity further comprises a map.

12. The activity of claim 8, wherein the activity further comprises a graph.

13. A learning kit for tutoring learners comprising:
at least one copy of a book;
at least one activity wherein the activity is in game format and is self-contained;
a container;
a learning kit instruction sheet; and
a progress chart.

14. The activity of claim 13, wherein the activity is contextually related to the book of claim 1.

15. A method for tutoring a learner by using a learning kit of claim 1, comprising:
a tutor's reading of the book to a learner;
the learner's engagement of at least one activity in the learning kit.
